(19) United States
(12) Patent Application Publication
(10) Pub. No.: US 2011/0159145 A1
(43) Pub. Date: Jun. 30, 2011

(54) IMPROVED EDIBLE COMPOSITIONS AND METHOD FOR PREPARING IT

(75) Inventors: Pirjo Alho-Lehto, Vanhalinna (FI); Paivi Kuusisto, Naantali (FI)

(73) Assignee: RAISIO NUTRITION LTD, Raision (FI)

(21) Appl. No.: 13/060,732

(22) PCT Filed: Aug. 31, 2009
(86) PCT No.: PCT/FI09/00080

§ 371 Date: Feb. 25, 2011

(30) Foreign Application Priority Data
Sep. 1, 2008 (FI) 20080492

(51) Int. Cl. A23L 1/10; A23L 1/302; A23L 1/303; A23L 1/305; A23L 1/304; A23L 2/38; A23L 1/05; A23C 11/00; A23L 1/105

(52) U.S. Cl. 426/18; 426/615; 426/72; 426/61; 426/73; 426/74; 426/590; 426/573; 426/622

(57) ABSTRACT

The invention relates to an oat suspension, a process for preparation thereof and a powder made thereof. The suspension and the powder can be used for preparing drinks and other non-dairy products with improved sensory properties.

### FIELD OF INVENTION

The invention relates to an oat suspension which has good sensory properties, to the preparation thereof and to a powder prepared from the suspension, and to drinks and other food products containing the suspension or the powder.

### BACKGROUND OF THE INVENTION

Oats have traditionally been consumed mainly as breakfast cereals and in bakery products. During the last years new type of oat products have been developed. Examples are non-dairy products, such as oat milk and other oat drinks as well as oat creams, desserts and fermented products such as yoghurt-like products (i.e. non-dairy yoghurt).

Oat milks and other oat drinks have most commonly been prepared by treating oat raw material with enzymes to break down the chemical constituents, especially starch. Several processes have been described. Starch is degraded into sugars, especially maltose. The other constituents, like proteins and fibres, may remain intact or may be enzymatically degraded as well.

WO 95/07628 describes a homogenous and stable cereal suspension having the taste and aroma of natural oats and comprising intact β-glucans. The suspension is prepared by treating oatmeal suspension first with β-amylase, which specifically generates maltose units and has no glucanase and proteinase effect, and thereafter with α-amylase, which specifically generates maltose units and has no glucanase and proteinase effect.

WO 00/22938 provides a method for producing cereal suspensions having the aroma and/or flavor of natural cereals. The method includes treating a cereal substrate suspension with an enzyme preparation which comprises at least one hydrolase having the ability to hydrolyse a-glycosidic bonds and having no glucanase and proteinase effect. The hydrolase may be selected from the group consisting of β-amylase, α-amylase, amyloglucosidase and pullulanase, with the proviso that when the enzyme preparation comprises β-amylase or α-amylase there is always a mixture of at least one other of the α-glycosidic hydrolases.

WO 02/065855 discloses a non-dairy, ready-to-use milk substitute prepared by the steps, which comprise: (i) providing a cereal suspension; (ii) providing a starch degrading enzyme composition devoid of β-glucanase and proteinase activity comprising a α-amylase and β-amylase, and (iii) treating said cereal suspension with said enzyme composition by introducing the β-amylase and the α-amylase simultaneously to said cereal suspension.

WO 03/075683 discloses starch modified oat and a preparation method thereof. The starch modified oat has a glucose content of at least 2 g/100 g on dry weight basis and β-glucan content of at least 4 g/100 g on dry weight basis. The starch modified oat contains also maltose of at least 30 g/100 g on dry weight basis. The starch modified oat is prepared by using α-amylase(s) and/or carbohydrase(s) in the first hydrolysis step and β-amylase(s) in the second hydrolysis step.

U.S. Pat. No. 4,377,602 discloses a preparation of hydrolysed products from whole grain. Whole grain is treated with a proteolytic enzyme and an amylase to transform protein and starch which is insoluble in water into water soluble products.

U.S. Pat. No. 5,723,162 describes a non-dairy frozen confection which is formed from a syrup using conventional techniques. The syrup is produced by liquefying and saccharifying a starch source, which is primarily oat flour or waxy barley hybrid flour.

U.S. Pat. No. 6,685,974 discloses a process for preparing an oat-based functional syrup. The process includes milling an oat material to produce a base formulation. Material having a granulation of more than U.S. #100 mesh is separated from the base formulation. The base formulation is then blended with water to form a slurry. Effective amounts of α-amylase enzyme and glucoamylase enzyme are mixed into the slurry. The slurry is then cooked to convert the slurry into a syrup.

WO 00/30457 discloses a process for preparing an oat-derived base comprising: preparing an oat based slurry having a solids content of between 5 and 45% oat substrate by weight, said oat substrate containing β-glucan and oat starches; heating the slurry to gelatinize at least a portion of the oat starches; adding an effective amount of at least an enzyme that has substantially no β-glucanase activity and digesting to the desired endpoint; and inactivating said enzyme to yield the liquid oat base.

Despite these different methods to prepare oat suspensions or syrups for use in e.g. non-dairy milks and other drinks and food products there is still a need for new improved methods and products. Almost all above mentioned processes aim at releasing the β-glucan from the oat raw material into the oat suspension. This intact or high molecular weight β-glucan is known to remarkably increase viscosity and to make the mouthfeel of the product slimy, which are disadvantages in drinks, especially those intended to be consumed as non-dairy milk. Other disadvantages with the known oat suspensions are the strong taste of oat and the dark colour such as greyish or even brownish off-colour. There have been attempts (U.S. Pat. No. 6,685,974) to diminish the dark colour and the strong oat taste by removing substantial portions of the bran before the actual enzymatic hydrolysis. This was accomplished by milling to a small particle size and removing the fraction rich in bran, i.e. the larger particles. However, this restricts the oat raw material which can be used for making the suspension. The thereby produced suspension was also too sweet to be used as non-dairy milk. Thus, also suitable sweetness of an oat suspension consumed as non-dairy milk is desirable to obtain a pleasant taste of the suspension. Oat suspensions having high glucose content have been used for preparation of sweet confections and sweet flavoured drinks, but they are too sweet to be used as non-dairy milk. On the other hand, known oat suspensions having high maltose content are less sweet, but their strong taste of oat is not appealing to the consumers.

Therefore, there is still a need for oat suspensions with good sensory properties, including good structure, pleasant mouthfeel, no or only a mild oat taste, light colour, and suitable sweetness, and also for a simple method for preparation of such oat suspensions.

### SUMMARY OF THE INVENTION

The present invention provides an oat suspension suitable to be used as non-dairy milk as such or diluted, and/or further including suitable food ingredients. The suspension can also be in the form of flavoured oat drinks as well as other drinks and food products and/or it can be fermented.

Compared to prior art the oat suspension of the present invention has improved sensory properties, i.e. taste, structure, mouthfeel and colour. The taste is good as the suspension has practically no or only mild oat taste without being sugary. The colour is very light which is beneficial especially in oat suspensions consumed as non-dairy milk. The oat suspensions have pleasant mouthfeel and structure, i.e. have low viscosity and no sliminess.

The invention is also directed to a process for preparing the oat suspension by enzymatic treatment of suspended oat raw material.

The invention is further directed to powders prepared from the oat suspensions.

Even further the invention is directed to non-dairy products containing the oat suspension or the powder.

The characterising features of the present invention are set forth in the claims.

### DETAILED DESCRIPTION OF THE INVENTION

The present invention provides an oat suspension containing an enzyme modified oat raw material with good sensory properties such as good taste, colour, structure and mouthfeel. Surprisingly, it was found that this may be achieved by certain selections in the composition of the suspension.

By oat raw material is here meant material obtainable from dehulled oat grain or part of the dehulled oat grain. Examples of oat raw materials are rolled oats, whole oat flour, endosperm oat flour, oat bran and their mixtures, preferably rolled oats and whole oat flour.

The oat suspension according to the invention is produced by enzymatically treating a mixture of oat raw material and water in such a way that at least part of the starch is hydrolysed to glucose and other sugars.

The invention is directed to an oat suspension, optionally fermented, containing enzymatically treated oat raw material, water and optionally at least one food ingredient, characterised in that the suspension comprises on dry weight basis 8-75% glucose, 0-15% maltose, and at most 3.0% β-glucan originating from the oat raw material.

The glucose content of the oat suspension according to the invention is sufficient to provide suitable sweetness but not too high to taste sugary. The glucose content in the suspension is 8-75%, preferably 15-70%, more preferably 20-65%, and most preferably 25-60% on dry weight basis (dwb).

In addition to glucose, the suspension preferably also comprises maltose in an amount of 0-15%, preferably 0-10%, more preferably 0-8% and most preferably 0-5% (dwb). Low amount of maltose may exist, e.g. 0.1-10%, preferably 0.2-8%, more preferably 0.3-6%, still more preferably 0.4-4%, and most preferably 0.5-3 (dwb). A suitable ratio of glucose to maltose in the suspension is 1:1-99:1, preferably 2:1-25:1, more preferably 2.5:1-20:1, still more preferably 4:1-15:1, and most preferably 5:1-10:1. This provides a suspension with a balanced sweetness appealing to consumers.

The β-glucan content in the oat suspension, originating from the oat raw material, should be very low, i.e. at most 3.0%, preferably at most 2.0%, more preferably at most 1.0%, still more preferably at most 0.5% (dwb), and most preferably there is no β-glucan originating from the oat raw material in the suspension. This feature of the suspension will give it good sensory properties, including suitable viscosity and lack of sliminess.

Further, it was found that the protein originating from the oat raw material should have a degree of hydrolysis of at most 10%, preferably at most 8%, more preferably at most 6%, still more preferably at most 4%, still more preferably at most 2%, and most preferably 0% in the suspension. The suspension preferably contains such protein in an amount of 0.1-20%, more preferably 0.5-15%, still more preferably 1-12%, and most preferably 2-10% (dwb). These features will both have a positive impact on the sensory properties, especially on the taste of the suspension.

The protein content can be analysed by the Kjeldahl method. The degree of hydrolysis of the protein is the extent to which peptide bonds are broken by an enzymatic hydrolysis reaction. The degree of hydrolysis can be analysed by the OPA method (Nielsen P. M. et al., Journal of Food Science, 2001, vol. 66, no 5, 642), which is based on the reaction of primary amino groups with o-phthaldialdehyde (OPA).

As used here “non-fibre oligosaccharides” refers to oligosaccharides that have a degree of polymerisation (DP) between 3-20 and are not resistant to digestion and absorption in the human small intestine. Most of the non-fibre oligosaccharides in the oat suspension are derived from starch that has been at least partly degraded in the preparation process of the oat suspension. Also other non-fibre oligosaccharides may be present. Non-fibre oligosaccharides can also raise the viscosity of the oat suspension. Therefore, the amount of such oligosaccharides in the suspension should preferably be limited to 1-40%, more preferably to 2-30%, still more preferably to 2.5-25%, still more preferably to 3-20%, still more preferably to 3.5-15%, and most preferably to 4-10% (dwb).

All starch in the oat raw material is not necessarily hydrolysed. Thus there may be 0-25%, preferably 0-20%, more preferably 0-15%, and most preferably 0-10% (dwb) starch in the suspension. Low amount of starch may exist, e.g. 0.1-20%, preferably 0.2-15%, more preferably 0.3-10%, and most preferably 0.4-5% (dwb).

The sugar and non-fibre oligosaccharide content and profile of the oat suspension can be analysed by an ion chromatographic method (Dionex CarboPac PA-100 column, pulse amperometric detector ED50). The starch can be analysed by AOAC method 996.11 and β-glucan by AOAC method 995.16.

The oat suspension according to the invention comprises enzymatically treated oat raw material 15-100%, preferably 25-99%, more preferably 40-98%, still more preferably 60-97%, and most preferably 80-96% on dry weight basis.

The amount of enzymatically treated oat raw material in the suspension is 2-30%, preferably 3-20%, more preferably 4-15%, and most preferably 5-10% by weight.

All oat suspensions according to the invention that are drinkable have a viscosity of at most 700 mPas, preferably at most 500 mPas, more preferably at most 300 mPas, and most preferably at most 100 mPas. The viscosity can be measured at 20° C. using a Sine-wave Vibro Viscometer, model SV-10 (A&D Company, Ltd). Therefore, e.g. spoonable non-dairy yoghurts and ice-cream like products may have a higher viscosity.

The dry matter content of the oat suspension can be adjusted by diluting the suspension with water or by evaporating it to a wanted concentration.

The oat suspension according to the invention may be fermented, preferably with lactic acid bacteria or bifidobacteria. This enables the oat suspension to be e.g. a spoonable or drinkable non-dairy yoghurt.

The oat suspension can contain only the enzymatically treated oat raw material and water. However, at least one food ingredient may be added. The optional food ingredient may include food additives such as stabilisers, emulsifiers, sweetening agents (e.g. saccharose, starch syrup, fructose, aspartame, sorbitol, sodium cyclamate, acesulfame K and sucralose), preservatives, flavourings (e.g. vanilla, fruit or berry flavors), fats, oils, cocoa, or any mixtures thereof. The optional food ingredient may include vegetable, fruit and/or berry materials, such as vegetable juice or puree; fruit juice, puree, jam or marmalade; berry juice, puree, jam or marmalade; or any mixtures thereof. The optional food ingredient may include nutritionally beneficial components such as vitamins, minerals, plant sterols and/or plant stanols, omega-3 fatty acids, dietary fibres, purified proteins, probiotics or any mixtures thereof. An example of vitamins is vitamin D. Of minerals, especially calcium is preferred. If calcium is added, its concentration is preferably adjusted to at least the same level as in dairy milk. Plant sterols and/or plant stanols may preferably be added in a form of plant sterol ester and/or plant stanol ester. In this specification the plant sterols include 4-desmethyl sterols, 4-monomethyl sterols and 4,4-dimethyl sterols (triterpene alcohols) and the plant stanols include 4-desmethyl stanols, 4-monomethyl stanols and 4,4-dimethyl stanols. As used here, the term “plant sterol ester” or “plant stanol ester” refers to plant sterols or plant stanols having at least 60%, preferably at least 85%, most preferably at least 95% of the plant sterols and/or plant stanols in esterified form. In this invention the plant sterol esters and/or plant stanol esters are esterified with an organic acid, preferably with fatty acids, most preferably with vegetable oil based fatty acids, such as fatty acids from sunflower oil or soybean oil. Oils rich in omega-3 fatty acids include fish oils and vegetable oils such as camelina oil, linseed oil and rapeseed oil, and their fatty acids may preferably be used in the plant sterol ester and/or plant stanol ester. Preferred oils are of vegetable origin.

The dietary fibre is preferably soluble dietary fibre. The term “soluble dietary fibre” as used herein refers to non-starch polysaccharides characterised as being water soluble. The soluble dietary fibre is added to the ready oat suspension, after the enzymes have been inactivated and the insoluble fraction of oat raw material removed. Examples of suitable soluble dietary fibres are purified β-glucan, polydextrose, inulin and other fructo-oligosaccharides, pectin and its derivatives, arabinoxylans, arabinogalactans, psyllium, alginates, carrageenan and vegetable gums such as konjac gum, xanthan gum, guar gum (guaran gum), locust bean gum, gum tragacanth, arabic gum and gellan gum. By adding soluble dietary fibre afterwards, a product with high fibre content can be achieved without compromising the sensory properties. A preferred soluble dietary fibre is purified β-glucan, especially purified cereal β-glucan, such as oat or barley derived β-glucan. The term “purified β-glucan” as used here refers to soluble β-glucan preparations that do not cause off-colours or cereal taste to the oat suspension. Preferably low molecular weight β-glucan is used. Preferably the β-glucan has an average molecular weight of at most 500 000 Daltons, more preferably at most 200 000 Daltons. The molecular weight can be determined e.g. by size exclusion chromatography.

If an oat suspension with high protein content is desired, purified protein may be added to the oat suspension. The purified protein is added to the ready oat suspension, after the enzymes have been inactivated and the insoluble fraction of oat raw material removed. Examples of suitable proteins are proteins of plant origin, especially cereal proteins and soybean protein. The term “purified protein” as used here refers to proteins and hydrolysis products thereof that do not cause off-colours (such as brownish or greyish colour) or off-flavours (such as displeasing cereal flavour) to the oat suspension. By adding purified proteins afterwards, an oat suspension with high protein content can be achieved without compromising the sensory properties.

The suspension can be in the form of various non-dairy edible compositions, in e.g. non-dairy milk, non-dairy cream, non-dairy flavoured drinks, non-dairy desserts such as ice-cream-like products, and fermented non-dairy products such as yoghurt-like products (i.e. non-dairy yoghurt). The compositions are suitable also to people allergic to dairy components.

The invention therefore further relates to an oat suspension, optionally fermented, which is a non-dairy edible composition, containing at least one food ingredient selected from the group consisting of salt; vegetable oil/fat; calcium and/or other mineral; vitamin D and/or other vitamin; stabiliser; sweetening agent such as saccharose and/or starch syrup; acidifier; emulsifier; flavouring; cocoa powder; vegetable, fruit and/or berry materials; purified protein; soluble dietary fibre; plant sterol and/or plant stanol; and probiotics.

The suspension is especially suitable for use as non-dairy milk because of the favourable sensory properties. A preferred non-dairy edible composition is therefore a non-dairy milk comprising the oat suspension according to the invention. The non-dairy milk contains at least one food ingredient selected from the group consisting of salt, preferably in an amount of 0.01-0.3 g, vegetable oil, preferably in an amount of 0.1-5 g, calcium, preferably in an amount of 0.05-0.3 g, vitamin D, preferably in an amount of 0.1-2 mg, and stabiliser, preferably in an amount of 0.01-2 g per 100 g non-dairy milk. Preferably the non-dairy milk contains all these food ingredients. The non-dairy milk can also contain plant sterol and/or plant stanol, preferably in an amount of 0.1-10 g per 100 g non-dairy milk.

Another preferred non-dairy edible composition is a non-dairy cream, such as cooking cream, whipping cream or dessert cream (such as vanilla custard), comprising the oat suspension according to the invention. The non-dairy cream contains at least one food ingredient selected from the group consisting of sweetening agent such as saccharose and/or starch syrup, preferably in an amount of 0.1-10 g; acidifier, preferably in an amount of 0.05-1 g; emulsifier, preferably in an amount of 0.01-2 g; stabiliser, preferably in an amount of 0.1-5 g; salt, preferably in an amount of 0.01-0.3 g; flavouring such as cream/milk arome or vanilla, preferably in an amount of 0.01-1 g; and vegetable oil/fat, preferably in an amount of 1-40 g per 100 g non-dairy cream. The non-dairy cream can also contain plant sterol and/or plant stanol, preferably in an amount of 0.1-10 g per 100 g non-dairy cream.

Still another preferred non-dairy edible composition is a non-dairy flavoured drink comprising the oat suspension according to the invention. The non-dairy flavoured drink contains at least one food ingredient selected from the group consisting of sweetening agent such as saccharose, preferably in an amount of 0.1-10 g; cocoa powder, preferably in an amount of 0.5-5 g; vegetable oil, preferably in an amount of 0.1-5 g; calcium, preferably in an amount of 0.05-0.3 g; stabiliser, preferably in an amount of 0.01-2 g; salt, preferably in an amount of 0.01-0.3 g; vitamin D, preferably in an amount of 0.1-2 μg; flavouring, preferably in an amount of 0.01-1 g; vegetable, fruit and/or berry materials, preferably in an amount of 1-30 g; soluble dietary fibre, preferably in an amount of 0.01-10 g; and plant sterol and/or plant stanol, preferably in an amount of 0.1-10 g per 100 g non-dairy flavoured drink. By flavoured drink is meant a drink containing any component delivering flavour to the drink, such as cocoa; flavouring; and vegetable, fruit and/or berry materials.

Yet another preferred non-dairy edible composition is a spoonable or drinkable non-dairy yoghurt comprising the oat suspension according to the invention. Preferably, the non-dairy yoghurt is prepared by conventional fermenting techniques. The non-dairy yoghurt contains at least one food ingredient selected from the group consisting of sweetening agent such as saccharose, preferably in an amount of 0.1-10 g; emulsifier, preferably in an amount of 0.05-1 g; stabiliser, preferably in an amount of 0.05-10 g; flavouring, preferably in an amount of 0.01-1 g; vegetable oil/fat, preferably in an amount of 0.5-5 g; purified protein such as soy bean protein isolate, preferably in an amount of 0.1-10 g; fruit and/or berry materials, preferably in an amount of 1-40 g; soluble dietary fibre, preferably in an amount of 0.01-10 g; and plant sterol and/or plant stanol, preferably in an amount of 0.1-10 g per 100 g non-dairy yoghurt. Examples of suitable bacteria that can be used for the preparation of the non-dairy yoghurt are the cultures used conventionally for yoghurt preparation, such as lactic acid bacteria and bifidobacteria.

The invention also relates to the preparation of an oat suspension usable in oat drinks such as oat milk with good taste, colour, structure and mouthfeel. The suspension may also find use in other kind of edible non-dairy compositions such as non-dairy cream, yoghurt-like products and ice-cream-like products.

The suspension is prepared by enzymatic treatment of a mixture of oat raw material in water. Surprisingly, it was found that an oat suspension with desired properties may be produced with careful selection of the type of enzymes and the particle size of the raw material.

Thus, the invention relates to a process for the preparation of an oat suspension including the steps of

A preparing a mixture of oat raw material and water
B milling the oat raw material
C treating the oat raw material with at least one α-amylase and at least one enzyme producing glucose
D inactivating the enzymes
E removing insolubles at least partly to form an oat suspension
F optionally adjusting dry matter content of the suspension
G optionally homogenising, pasteurising and/or UHT treating the suspension
H optionally fermenting the suspension and
I optionally adding at least one food ingredient to the suspension
characterised in that the oat raw material is milled so that at least 50% of the particles are larger than 200 μm and enzymes with substantially no protease activity are used.

The oat raw material may contain all material in the dehulled grain, i.e. not only the endosperm fraction but also the bran part may be present as the process does not release too much β-glucan to the suspension. Thus, rolled oats, whole oat flour, endosperm oat flour, oat bran and their mixtures are usable as oat raw material. Preferably rolled oats or whole oat flour are used as oat raw material in the process according to the invention.

It was surprisingly found that by using a particle size of the oat raw material that is large enough good sensory properties of the suspension were achieved. At least 50%, preferably at least 65%, more preferably at least 80% and most preferably all of the particles are larger than 200 μm when the enzymatic treatment is started. This may require milling of the oat particles to a suitable particle size before mixing with water, during mixing or after the particles have been suspended in water.

The mixture of oat raw material of suitable particle size distribution and water has a dry matter content from 3 to 50%, preferably 5-40%, more preferably 8-30% and most preferably 10-25% when the enzymatic treatment is started.

The mixture is treated enzymatically to degrade at least part of the starch in the particles mainly to glucose but also to other sugars, e.g. maltose may be present.

The mixture is treated with at least one α-amylase and at least one enzyme producing glucose followed by deactivation of the enzymes. Preferably, the enzymes are allowed to function simultaneously. It is also possible to treat the oat material first with α-amylase, deactivating it and then repeating the same with the enzyme producing glucose. However, this latter possibility is more complicated and time consuming

The amount of enzymes and the process conditions e.g. temperature and reaction time may vary depending e.g. on the activity of the enzymes and the oat material content. However, the skilled man is competent to determine suitable parameters.

The enzymes are inactivated when a suitable consistency of the suspension has been achieved. The inactivation may take place e.g. by adjusting the pH or preferably by raising the temperature of the suspension e.g. to 80-150° C., and preferably to 80-130° C. for a sufficient time.

The enzyme producing glucose hydrolyses starch in the oat raw material and especially dextrins or oligosaccharides formed by the α-amylase(s) to glucose. The enzyme producing glucose is not an α-amylase according to the definition of this invention. Non-limiting examples of the enzymes producing glucose are glucoamylase (EC 3.2.1.3), α-glucosidase (EC 3.2.1.20), amylo-1,6-glucosidase (EC 3.2.1.33) and oligo-1,6-glucosidase (EC 3.2.1.10). Preferably the enzyme producing glucose is glucoamylase (EC 3.2.1.3), which catalyses the release of successive glucose units from the non-reducing end of dextrin and oligosaccharide chains by hydrolysing both linear (1,4-α-D) and branched (1,6-α-D) glucosidic bonds. The enzymes may be from microbial, animal or plant origin and may be used as free enzymes or immobilised enzymes.

The order of the process steps may vary to some extent, e.g. step B can precede step A and/or step I can precede step H or even step G.

The process according to the invention results in sufficiently low amounts of β-glucan and protein, both originated from the oat raw material, in the suspension. The process is so gentle that there is no need to remove the bran fraction of the oat material, which contains much β-glucan, nor to remove the proteins, before performing the enzymatic treatment according to the present invented process. The process therefore results in a suspension having a β-glucan content, originating from the oat raw material, of at most 3.0%, preferably at most 2.0%, more preferably at most 1.0%, still more preferably at most 0.5% (dwb) and most preferably there is no β-glucan originating from the oat raw material in the suspension. The enzymes used in the process according to the invention have substantially no protease activity, i.e. they do not substantially hydrolyse protein in the oat raw material. The process therefore results in a suspension having protein originating from the oat raw material with a degree of hydrolysis of at most 10%, preferably at most 8%, more preferably at most 6%, still more preferably at most 4%, still more preferably at most 2%, and most preferably 0% in the suspension. The suspension contains such protein in an amount of 0.1-20%, preferably in an amount of 0.2-15%, more preferably in an amount of 0.3-10% and most preferably in an amount of 0.4-5 (dwb).

The heavier fraction of insolubles in the suspension is separated. Suitable methods for this process step are decantation, centrifugation and filtration. An advantage of using a large particle size of the oat raw material in the process is that this separation step is easy to accomplish. Preferably the inactivation of the enzymes is performed before the separation step of the insolubles.

The suspension may be diluted in case the solid contents is still too high for the purposed use. It may also be homogenised, pasteurised and/or UHT treated. It is also possible to include one or several food ingredients depending on the use of the suspension. The suspension can also be fermented.

The invention also relates to a powder produced from the suspension according to the invention or from the suspension prepared according to the invention. The powder thus contains enzymatically treated oat raw material, is optionally fermented and optionally also contains one or several of the food ingredients. The powder is in substantially dry state, e.g. containing 0-10%, preferably 0-5% by weight of water. The powder can be produced by drying the oat suspension by any known technique, preferably by spray drying.

The suspension and the powder are useful in various non-dairy edible compositions, in e.g. non-dairy milk, non-dairy cream, non-dairy flavoured drinks, non-dairy desserts such as ice-cream-like products, and fermented non-dairy products such as yoghurt-like products. Thus, it would be rational to produce a basic suspension or powder, which contains no food ingredients or only those common to all or at least to most end products. In the preparation of the basic suspension or powder, only those process steps would be used, which are common to the preparation of all or at least to most of the end products. The basic suspension or powder is then used as starting material in the preparation of the final product. The still missing food ingredients are added and/or necessary preparation steps are performed.

The invention therefore further relates to a non-dairy edible composition comprising the oat suspension or the powder according to the invention, containing at least one food ingredient selected from the group consisting of salt; vegetable oil/fat; calcium and/or other mineral; vitamin D and/or other vitamin; stabiliser; sweetening agent such as saccharose and/or starch syrup; acidifier; emulsifier; flavouring; cocoa powder; vegetable, fruit and/or berry materials; purified protein; soluble dietary fibre; plant sterol and/or plant stanol; and probiotics.

The suspension is especially suitable for use as non-dairy milk because of the favourable sensory properties. A preferred non-dairy edible composition is therefore a non-dairy milk comprising the oat suspension or the powder according to the invention. The non-dairy milk contains at least one food ingredient selected from the group consisting of salt, preferably in an amount of 0.01-0.3 g, vegetable oil, preferably in an amount of 0.1-5 g, calcium, preferably in an amount of 0.05-0.3 g, vitamin D, preferably in an amount of 0.1-2 μg, and stabiliser, preferably in an amount of 0.01-2 g per 100 g non-dairy milk. Preferably the non-dairy milk contains all these food ingredients. The non-dairy milk can also contain plant sterol and/or plant stanol, preferably in an amount of 0.1-10 g per 100 g non-dairy milk.

Another preferred non-dairy edible composition is a non-dairy cream, such as cooking cream, whipping cream or dessert cream (such as vanilla custard), comprising the oat suspension or the powder according to the invention. The non-dairy cream contains at least one food ingredient selected from the group consisting of sweetening agent such as saccharose or starch syrup, preferably in an amount of 0.1-10 g; acidifier, preferably in an amount of 0.05-1 g; emulsifier, preferably in an amount of 0.01-2 g; stabiliser, preferably in an amount of 0.1-5 g; salt, preferably in an amount of 0.01-0.3 g; flavouring such as cream/milk arome or vanilla, preferably in an amount of 0.01-1 g; and vegetable oil/fat, preferably in an amount of 1-40 g per 100 g non-dairy cream. The non-dairy cream can also contain plant sterol and/or plant stanol, preferably in an amount of 0.1-10 g per 100 g non-dairy cream.

Still another preferred non-dairy edible composition is a non-dairy flavoured drink comprising the oat suspension or the powder according to the invention. The non-dairy flavoured drink contains at least one food ingredient selected from the group consisting of sweetening agent such as saccharose, preferably in an amount of 0.1-10 g; cocoa powder, preferably in an amount of 0.5-5 g; vegetable oil, preferably in an amount of 0.1-5 g; calcium, preferably in an amount of 0.05-0.3 g; stabiliser, preferably in an amount of 0.01-2 g; salt, preferably in an amount of 0.01-0.3 g; vitamin D, preferably in an amount of 0.1-2 μg; flavouring, preferably in an amount of 0.01-1 g; vegetable, fruit and/or berry materials, preferably in an amount of 1-30 g; soluble dietary fibre, preferably in an amount of 0.01-10 g; and plant sterol and/or plant stanol, preferably in an amount of 0.1-10 g per 100 g non-dairy flavoured drink. By flavoured drink is meant a drink containing any component delivering flavour to the drink, such as cocoa; flavouring; and vegetable, fruit and/or berry materials.

Yet another preferred non-dairy edible composition is a spoonable or drinkable non-dairy yoghurt comprising the oat suspension or the powder according to the invention. Preferably, the non-dairy yoghurt is prepared by conventional fermenting techniques. The non-dairy yoghurt contains at least one food ingredient selected from the group consisting of sweetening agent such as saccharose, preferably in an amount of 0.1-10 g; emulsifier, preferably in an amount of 0.05-1 g; stabiliser, preferably in an amount of 0.05-10 g; flavouring, preferably in an amount of 0.01-1 g; vegetable oil/fat, preferably in an amount of 0.5-5 g; purified protein such as soy bean protein isolate, preferably in an amount of 0.1-10 g; fruit and/or berry materials, preferably in an amount of 1-40 g; soluble dietary fibre, preferably in an amount of 0.01-10 g; and plant sterol and/or plant stanol, preferably in an amount of 0.1-10 g per 100 g non-dairy yoghurt. Examples of suitable bacteria that can be used for the preparation of the non-dairy yoghurt are the cultures used conventionally for yoghurt preparation, such as lactic acid bacteria and bifidobacteria.

The following examples illustrate the present invention without limiting it.

### Example 1

An oat suspension was prepared of rolled oats and water. Rolled oats were milled and suspended into water 60° C. (dry matter content 20%). The particle size was determined by analysing a sample of the milled oat raw material by a screening technique. 100% of the flour was retained on a 200 μm screen. The oat raw material was then treated with α-amylase (Fungamyl 800L, Novozymes, 0.07% of the oat raw material) and amyloglucosidase (Optidex L-400, Genencor International, 0.18% of the oat raw material) at 60° C. for 3 hours. The enzymes were then inactivated at 85° C. and the insoluble fraction was separated by decantation (Foodec 310 decanter). The dry matter content of the resulting oat suspension was adjusted to 10%.

The sugar and non-fibre oligosaccharide content and profile of the oat suspension was analysed by an ion chromatographic method (Dionex CarboPac PA-100 column, pulse amperometric detector ED50). The protein content was analysed by the Kjeldahl method, the degree of hydrolysis of the protein by the OPA method, the starch by the AOAC 996.11 method, and the β-glucan by the AOAC 995.16 method.

TABLE 1
The composition of the oat suspension

| | g/100 g dry weight |
|---|---|
| glucose | 42 |
| maltose | 6 |
| non-fibre oligosaccharides, DP3-DP20 | 6 |
| protein | 3 |
| degree of hydrolysis of the protein | 0 |
| starch | 22 |
| β-glucan | 0.0 |

The ratio of glucose to maltose was 7:1.

The sensory properties of the oat suspension were evaluated in Examples 6 and 7.

### Example 2

An oat suspension was prepared of whole oat flour and water. The oats were milled by a laboratory mill (Laboratory Mill 3100). 85% of the oat flour was retained on a 200 μm screen, 65% on a 265 μm screen, 45% on a 400 μm screen; 25% on a 670 μm screen, 5% on a 850 μm screen and traces on a 1000 μm screen. Oat flour was suspended into water at 60° C. (dry matter content 20%). The oat raw material was then treated with α-amylase (Fungamyl 800L, Novozymes, 0.07% of the oat raw material) and amyloglucosidase (Optidex L-400, Genencor International, 0.18% of the oat raw material) at 60° C. for 3 hours. The enzymes were then inactivated at 85° C. and the insoluble fraction was separated by centrifugation. The dry matter content of the resulting oat suspension was adjusted to 10%. Rape-seed oil in an amount of 0.5 g and vitamin D in an amount of 0.5 μg per 100 g of the suspension were added.

TABLE 2
The composition of the oat suspension

| | g/100 g dry weight |
|---|---|
| glucose | 52 |
| maltose | 5 |
| non-fibre oligosaccharides, DP3-DP20 | 12 |
| protein | 9 |
| β-glucan | 0.0 |

The ratio of glucose to maltose was 10:1.

The oat suspension had a light colour and a mild taste with almost no taste of oats.

### Example 3

An oat suspension was prepared of rolled oats and water as in Example 2, but the particle size being different. 54% of the oat flour was retained on a 200 μm screen.

TABLE 3
The composition of the oat suspension

| | g/100 g dry weight |
|---|---|
| glucose | 70 |
| maltose | 5 |
| protein | 4 |
| β-glucan | 0.5 |

The ratio of glucose to maltose was 14:1.

The sensory properties of the oat suspension were evaluated in Example 7.

### Example 4

Mixture of oat bran and rolled oats (bran content 20%) was milled and the particle size determined as in Example 1. 52% of the milled flour retained on a 200 μm screen. The flour was suspended into water at 60° C. (dry matter content 20%) and oat suspension prepared as in Example 1.

TABLE 4
The composition of the oat suspension

| | g/100 g dry weight |
|---|---|
| glucose | 23 |
| maltose | 0.3 |
| protein | 11 |
| β-glucan | 2.2 |

The ratio of glucose to maltose was 77:1.

The oat suspension had a mild taste with almost no taste of oats. The color was somewhat darker than in the oat suspension of example 3, but still very light and acceptable.

### Example 5

### Comparative Example

An oat suspension was prepared of rolled oats and water. The rolled oats were milled and the milled oat material was subjected to an extra process step (sieving) to remove larger size particles. The sieving step removed substantially all particle that were larger than 200 μm. The flour that passed a 200 μm screen was used in the preparation of the oat suspension. 51% of this flour passed also a 75 μm screen. The enzymatic reaction and decantation was done as described in Example 1. The oat suspension contained more dry matter after the decantation step than the oat suspensions of Examples 1-4 (13%) and even after diluting to 10% dry matter content the mouthfeel of the oat suspension was slimy.

TABLE 5
The composition of the oat suspension

| | g/100 g dry matter |
|---|---|
| glucose | 78 |
| maltose | 1 |
| protein | 9 |
| β-glucan | 4 |

The ratio of glucose to maltose was 78:1.

The sensory properties of the oat suspension were evaluated in Example 7.

### Example 6

### Sensory Analyses

The sensory properties of the oat suspensions were analysed by a trained sensory panel (n=23). The oat suspension of Example 1 (sample 1) was compared to an oat suspension prepared as in Example 2 of WO 95/07628 (sample 2).

The oat suspension of the current invention contained glucose as its main sugar, whereas maltose was the main sugar in the oat suspension of WO 95/07628. The oat suspension of WO 95/07628 contained also β-glucan and had the taste and aroma of natural oats. The dry matter content of the both suspensions was adjusted to 7% before the test.

The panellists were asked to evaluate the colour, structure and taste of the oat suspensions. The test was done as a pair-wise ranking test, in which the panellist chose the sample they preferred separately for each attribute. The panellists were also asked which sample had stronger taste of oat. The panellists were also asked to rank the samples 1 and 2 according to overall preference. The results are presented in Table 5.

TABLE 6
Percentage of the panellists preferring the sample.

| | sample 1 | sample 2 (reference) |
|---|---|---|
| Colour | 61 | 39 |
| Structure | 57 | 43 |
| Taste (overall taste) | 65 | 35 |
| Overall preference | 71 | 29 |

Sample 2 had stronger taste of oat according to 74% of the panellists. The weaker taste of oat in the sample 1 was an advantage and most of the panellists preferred sample 1 (71% of the panellists, overall preference). In addition to the weaker taste of oats, sample 1 was preferred also in other attributes (colour, structure and overall taste).

Sample 1 (oat suspension of the present invention) was said to have pleasant structure, colour and taste, balanced taste, less bitterness than sample 2 and only mild oat taste. The structure and mouthfeel were said to be pleasant and not too thin.

### Example 7

### Sensory Analyses

A trained sensory panel (n=33) evaluated the oat suspensions of Examples 1, 3 and 5 (samples A, B, C, respectively). The panellists were asked to drink 0.75 dl of each sample and to evaluate the suitability of each oat suspension to be used as non-dairy milk (oat milk) to be consumed together with a meal. The samples were given in a randomised order. The panellists evaluated the sweetness of the oat suspensions with a scale from −3 . . . 0 . . . +3, where −3 is not enough sweetness, 0 is suitable sweetness and +3 is too much sweetness and gave comments about the samples.

TABLE 7
Results from the sensory analysis

| | sample A | sample B | sample C |
|---|---|---|---|
| scores, mean | 0.0 | 1.6 | 2.7 |
| comments | suitable | sweetness good | too sweet to be consumed |
| | sweetness | for a non-dairy | as non-dairy milk |
| | is like milk | milk | I would not drink |
| | suitable as | good mouthfeel | might be used for |
| | non-dairy milk | is like UHT milk | preparing desserts |
| | neutral | would be good | thick mouthfeel |
| | mild | with cocoa | only children might |
| | | | like this |
| | | | not pleasant |

The oat suspension of Example 1 (sample A) proved to be most suitable to be consumed as a non-dairy milk (oat milk) together with a meal. It resembled milk. Also oat suspension of Example 3 (sample B) was considered to be suitable to be used as a drink, either as a non-dairy milk or as a drink consumed separately from a meal. It resembled UHT milk. Oat suspension of Example 5 had highest glucose content and was considered to be too sweet to be consumed as non-dairy milk. Also the slimy mouthfeel of the oat suspension of Example 5 was noticed. It was thought to be suitable for preparing desserts, but not to be consumed as a drink.

### Example 8

The oat suspension of Example 1 was used to prepare a raspberry flavoured oat drink.

| | | |
|---|---|---|
| Oat suspension of Example 1 | 91.35% | by weight |
| Raspberry juice | 8.0% | |
| Calcium carbonate | 0.2% | |
| Pectin | 0.45% | |

The ingredients were mixed and the drink was homogenised and pasteurised.

### Example 9

The oat suspension of Example 3 was dried (spray drying) into a powder having a dry matter content of 97% by weight. The powder was used to prepare a flavoured oat drink containing sea buckthorn berry.

| | |
|---|---|
| Oat suspension powder | 16.0% |
| Water | 77.85% |
| Sea buckthorn juice | 5.0% |
| Camelina oil | 1.0% |
| Flavouring | 0.15% |
| Ascorbic acid | |

The powder was mixed with water and the other ingredients added. The drink was homogenised and pasteurised.

### Example 10

The oat suspension of Example 1 was used to prepare an orange flavoured oat drink containing added soluble dietary fibre.

| | |
|---|---|
| Oat suspension of Example 1 | 85% |
| Orange juice | 8% |
| Sugar (saccharose) | 6% |
| Purified; low molecular weight β-glucan | 1% |

The ingredients were mixed and the drink was homogenised and pasteurised. The structure and the mouthfeel of the drink were pleasant.

### Example 11

Vegetable oil, salt, stabiliser, calcium and vitamin D were added to the oat suspension of Example 1 to produce a non-dairy milk.

| | |
|---|---|
| Oat suspension of Example 1 | 99.3% |
| Rapeseed oil | 0.5% |
| Sodium alginate | 0.06% |
| Salt | 0.05% |
| Vitamin D | |
| Tricalciumphosphate | |

The ingredients were mixed and the drink was homogenised and pasteurised. The product had an excellent taste, light colour, pleasant mouthfeel, and a good structure.

### Example 12

The oat suspension of Example 3 was used to prepare a chocolate flavoured oat drink.

| | |
|---|---|
| Oat suspension of Example 3 | 95% |
| Camelina oil | 0.6% |
| Carrageenan | 0.16% |
| Salt | 0.14% |
| Saccharose | 2.6% |
| Cocoa powder | 1.5% |

The ingredients were mixed and the drink was homogenised and pasteurised.

### Example 13

The oat suspension of Example 3 was used to prepare a vanilla flavoured oat drink.

| | |
|---|---|
| Oat suspension of Example 3 | 98.2% |
| Rapeseed oil | 0.5% |
| Sodium alginate | 0.05% |
| Salt | 0.15% |
| Flavouring (vanilla) | 0.2% |

The ingredients were mixed and the drink was homogenised and pasteurised.

### Example 14

The oat suspension of Example 2 was used to prepare a non-dairy cream.

| | |
|---|---|
| Oat suspension of Example 2 | 92.3% |
| Rapeseed oil | 7% |
| Emulsifier | 0.1% |
| Citrate | 0.3% |
| Xanthan gum | 0.2% |
| Salt | 0.1% |

The ingredients were mixed and the drink was homogenised and pasteurised.

### Example 15

The oat suspension of Example 3 was used to prepare a non-dairy spoonable yoghurt.

| | |
|---|---|
| Oat suspension of Example 3 | 96.5% |
| Saccharose | 0.5% |
| Soy protein | 1.0% |
| Stabilisers (pectin, starch) | 2.0% |

The ingredients were mixed and the mixture was homogenised and pasteurised. The mixture was then fermented with lactic acid bacteria and Bifidobacterium lactis until pH had lowered to about 4.5. Strawberry jam was added to the fermented mixture in an amount of 17 g per 100 g non-dairy yoghurt.

1. An oat suspension, optionally fermented, containing enzymatically treated oat raw material, water and optionally at least one food ingredient, characterised in that the suspension comprises on dry weight basis:
glucose 8-75%, preferably 15-70%, more preferably 20-65%, and most preferably 25-60%,
maltose 0-15%, preferably 0-10%, more preferably 0-8%, and most preferably 0-5%, and
β-glucan, originating from the oat raw material, at most 3.0%, preferably at most 2.0%, more preferably at most 1.0%, still more preferably at most 0.5%, and most preferably no β-glucan originating from the oat raw material.

2. The suspension according to claim 1, characterised in that it has a ratio of glucose to maltose of 1:1-99:1, preferably 2:1-25:1, more preferably 2.5:1-20:1, still more preferably 4:1-15:1, and most preferably 5:1-10:1.

3. The suspension according to claim 1 characterised in that it comprises protein, originating from the oat raw material, having a degree of hydrolysis of at most 10%, preferably at most 8%, more preferably at most 6%, still more preferably at most 4%, still more preferably at most 2%, and most preferably 0%.

4. The suspension according to claim 1, characterised in that it comprises protein, originating from the oat raw material, 0.1-20%, preferably 0.5-15%, more preferably 1-12%, and most preferably 2-10% on dry weight basis.

5. The suspension according to claim 1, characterised in that it comprises non-fibre oligosaccharides 1-40%, preferably 2-30%, more preferably 3-20%, and most preferably 4-10% on dry weight basis.

6. The suspension according to claim 1, characterised in that it comprises starch 0-25%, preferably 0-20%, more preferably 0-15%, and most preferably 0-10% on dry weight basis.

7. The suspension according to claim 1, characterised in that it comprises enzymatically treated oat raw material 15-100%, preferably 25-99%, more preferably 40-98%, still more preferably 60-97%, and most preferably 80-96% on dry weight basis.

8. The suspension according to claim 1, characterised in that it comprises enzymatically treated oat raw material 2-30%, preferably 3-20%, more preferably 4-15%, and most preferably 5-10% by weight.

9. The suspension according to claim 1, characterised in that it has a viscosity of at most 700 mPas, preferably at most 500 mPas, more preferably at most 300 mPas, and most preferably at most 100 mPas.

10. The suspension according to claim 1, characterised in that the food ingredient is at least one selected from the group consisting of food additives; vegetable, fruit and/or berry materials; and nutritionally beneficial components, such as dietary fibre, purified protein, plant sterol and/or plant stanol, omega-3 fatty acid, probiotics, vitamin, and mineral.

11. The suspension according to claim 10, characterised in that the dietary fibre is at least one selected from the group consisting of polydextrose, purified β-glucan, fructo-oligosaccharide, pectin, alginate, carrageenan and gum, e.g. arabic, guar, xanthan, gellan or locust bean gum.

12. The suspension according to claim 1, characterised in that it is a non-dairy edible composition comprising at least one food ingredient selected from the group consisting of salt; vegetable oil/fat; calcium and/or other mineral; vitamin D and/or other vitamin; stabiliser; sweetening agent such as saccharose and/or starch syrup; acidifier; emulsifier; flavouring; cocoa powder; vegetable, fruit and/or berry materials; purified protein; soluble dietary fibre; plant sterol and/or plant stanol; and probiotics.

13. The composition according to claim 12, characterised in that it is a non-dairy milk containing at least one food ingredient selected from the group consisting of salt, preferably 0.01-0.3 g; vegetable oil, preferably 0.1-5 g; calcium, preferably 0.05-0.3 g; vitamin D, preferably 0.1-2 μg; stabiliser, preferably 0.01-2 g; and plant sterol and/or plant stanol, preferably 0.1-10 g per 100 g non-dairy milk.

14. The composition according to claim 12, characterised in that it is a non-dairy cream such as cooking cream, whipping cream or dessert cream (such as vanilla custard), containing at least one food ingredient selected from the group consisting of sweetening agent such as saccharose and/or starch syrup, preferably 0.1-10 g; acidifier, preferably 0.05-1 g; emulsifier, preferably 0.01-2 g; stabiliser, preferably 0.1-5 g; salt, preferably 0.01-0.3 g; flavouring such as cream/milk arome or vanilla; vegetable oil/fat, preferably 1-40 g; and plant sterol and/or plant stanol, preferably 0.1-10 g per 100 g non-dairy cream.

15. The composition according to claim 12, characterised in that it is a non-dairy flavoured drink containing at least one food ingredient selected from the group consisting of sweetening agent such as saccharose, preferably 0.1-10 g; cocoa powder, preferably 0.5-5 g; vegetable oil, preferably 0.1-5 g; calcium, preferably 0.05-0.3 g; stabiliser, preferably 0.01-2 g; salt, preferably 0.01-0.3 g; vitamin D, preferably 0.1-2 μg; flavouring, preferably 0.01-1 g; vegetable, fruit and/or berry materials, preferably 1-30 g; soluble dietary fibre, preferably 0.01-10 g; and plant sterol and/or plant stanol, preferably 0.1-10 g per 100 g non-dairy flavoured drink.

16. The composition according to claim 12, characterised in that it is a non-dairy spoonable or drinkable yoghurt containing at least one food ingredient selected from the group consisting of sweetening agent such as saccharose, preferably 0.1-10 g; emulsifier, preferably 0.05-1 g; stabiliser, preferably 0.05-10 g; flavouring, preferably 0.01-1 g; vegetable oil/fat, preferably 0.5-5 g; purified protein such as soy bean protein isolate, preferably 0.1-10 g; fruit and/or berry materials, preferably 1-40 g; soluble dietary fibre, preferably 0.01-10 g; and plant sterol and/or plant stanol, preferably 0.1-10 g per 100 g non-dairy yoghurt.

17. A process for the preparation of an oat suspension according to claim 1 including the steps of
(a) preparing a mixture of oat raw material and water;
(b) milling the oat raw material;
(c) treating the oat raw material with at least one α-amylase and at least one enzyme producing glucose;
(d) inactivating the enzymes;
(e) removing insolubles at least partly to form an oat suspension;
(f) optionally adjusting dry matter content of the suspension;
(g) optionally homogenising, pasteurising and/or UHT treating the suspension;
(h) optionally fermenting the suspension; and
(i) optionally adding at least one food ingredient to the suspension, characterised in that:
the oat raw material is milled so that at least 50%, preferably at least 65%, more preferably at least 80% and most preferably all of the particles are larger than 200 μm, and
enzymes with substantially no protease activity are used.

18. The process according to claim 17, characterised in that the oat raw material is at least one selected from the group consisting of rolled oats, whole oat flour, endosperm oat flour and oat bran, preferably at least one selected from the group consisting of rolled oats and whole oat flour.

19. The process according to claim 17, characterised in that the enzyme producing glucose is at least one selected from the group consisting of glucoamylase (EC 3.2.1.3), α-glucosidase (EC 3.2.1.20), amylo-1,6-glucosidase (EC 3.2.1.33) and oligo-1,6-glucosidase (EC 3.2.1.10), preferably glucoamylase (EC 3.2.1.3).

20. The process according to claim 17, characterised in that step B precedes step A, that step D precedes step E and/or that step I precedes step H or G.

21. A powder prepared from the suspension of claim 1.

22. A non-dairy edible composition comprising the oat suspension of claim 1, containing at least one food ingredient selected from the group consisting of salt; vegetable oil/fat; calcium and/or other mineral; vitamin D and/or other vitamin; stabiliser; sweetening agent such as saccharose and/or starch syrup; acidifier; emulsifier; flavouring; cocoa powder; vegetable, fruit and/or berry materials; purified protein; soluble dietary fibre; plant sterol and/or plant stanol; and probiotics.

23. The composition according to claim 22, characterised in that it is a non-dairy milk containing at least one food ingredient selected from the group consisting of salt, preferably 0.01-0.3 g; vegetable oil, preferably 0.1-5 g; calcium, preferably 0.05-0.3 g; vitamin D, preferably 0.1-2 μg; stabiliser, preferably 0.01-2 g; and plant sterol and/or plant stanol, preferably 0.1-10 g per 100 g non-dairy milk.

24. The composition according to claim 22, characterised in that it is a non-dairy cream such as cooking cream, whipping cream or dessert cream (such as vanilla custard), containing at least one food ingredient selected from the group consisting of sweetening agent such as saccharose and/or starch syrup, preferably 0.1-10 g; acidifier, preferably 0.05-1 g; emulsifier, preferably 0.01-2 g; stabiliser, preferably 0.1-5 g; salt, preferably 0.01-0.3 g; flavouring such as cream/milk arome or vanilla; vegetable oil/fat, preferably 1-40 g; and plant sterol and/or plant stanol, preferably 0.1-10 g per 100 g non-dairy cream.

25. The composition according to claim 22, characterised in that it is a non-dairy flavoured drink containing at least one food ingredient selected from the group consisting of sweetening agent such as saccharose, preferably 0.1-10 g; cocoa powder, preferably 0.5-5 g; vegetable oil, preferably 0.1-5 g; calcium, preferably 0.05-0.3 g; stabiliser, preferably 0.01-2 g; salt, preferably 0.01-0.3 g; vitamin D, preferably 0.1-2 μg; flavouring, preferably 0.01-1 g; vegetable, fruit and/or berry materials, preferably 1-30 g; soluble dietary fibre, preferably 0.01-10 g; and plant sterol and/or plant stanol, preferably 0.1-10 g per 100 g non-dairy flavoured drink.

26. The composition according to claim 22, characterised in that it is a non-dairy spoonable or drinkable yoghurt containing at least one food ingredient selected from the group consisting of sweetening agent such as saccharose, preferably 0.1-10 g; emulsifier, preferably 0.05-1 g; stabiliser, preferably 0.05-10 g; flavouring, preferably 0.01-1 g; vegetable oil/fat, preferably 0.5-5 g; purified protein such as soy bean protein isolate, preferably 0.1-10 g; fruit and/or berry materials, preferably 1-40 g; soluble dietary fibre, preferably 0.01-10 g; and plant sterol and/or plant stanol, preferably 0.1-10 g per 100 g non-dairy yoghurt.
